(19) United States
(12) Patent Application Publication
(10) Pub. No.: US 2009/0257084 A1
(43) Pub. Date: Oct. 15, 2009

(54) Image Processing Method, Computer Readable Recording Medium Stored With Image Processing Program, And Image Processing Apparatus

(75) Inventor: Shigeru Sakamoto, Kanagawa (JP)

Correspondence Address: SQUIRE, SANDERS & DEMPSEY L.L.P., 1 MARITIME PLAZA, SUITE 300, SAN FRANCISCO, CA, 94111, US

(73) Assignee: Konica Minolta Business Technologies, Inc., Tokyo (JP)

(21) Appl. No.: 12/405,152

(22) Filed: Mar. 16, 2009

(30) Foreign Application Priority Data
Apr. 15, 2008 (JP) 2008-106148

(51) Int. Cl. G06F 3/12

(52) U.S. Cl. 358/1.15

(57) ABSTRACT

A printer controller as an image processing apparatus having a plurality of processing units executes grouping a plurality of objects into one group for overlapping objects one of which overlaps with another object among the overlapping objects, and another group for independent object which does not overlap with another object. The printer controller calculates the drawing area for each of the groups obtained in the grouping process, and distributes the groups into the number of parallel processes to be executed by the plurality of processing units based on the calculated drawing area of each group.

### CROSS-REFERENCE TO RELATED APPLICATION

This application is based on Japanese Patent Application No. 2008-106148 filed on Apr. 15, 2008, the contents of which are incorporated herein by reference.

### BACKGROUND

1. Technical Field

The present invention relates to an image processing method, a computer readable recording medium stored with an image processing program, and an image processing apparatus. The present invention relates, in particular, to an image processing method, a computer readable recording medium stored with an image processing program, and an image processing apparatus for an efficient synthesizing process required for preparing page image data.

2. Description of Related Art

It takes an enormous amount of time to reproduce image data (hereinafter called also “raster image data”) in a bitmap-format used in printing in case of mass-printing such things as direct mail, labels and business forms where pictures and photographs are used abundantly.

As one solution to this, a system called “variable data printing” has been proposed. Variable data printing method means a printing method in which the output contents of each page can be partially replaced depending on the needs. In the variable data printing system, the print data contains reusable objects that can be used repeatedly and non-reuse objects that are used only once. Whether an object is a reusable object or a non-reuse object is also clearly differentiated in the layout information of the print data. The layout information also describes how object groups are laid out within a page.

Generally speaking, the rasterizing process and the synthesizing process are the two major processes used in printing apparatuses that support variable printing languages.

In the rasterizing process, raster image data prepared by applying RIP (Raster Image Processing) to reusable objects or data obtained by compressing the resultant raster image data are cached on memory devices or disks. The reusing of such cached raster image data or compressed data reduces the number of RIP processes and shortens the rasterizing process time.

On the other hand, since both reusable objects and non-reuse objects are the objects of processing, it is useless to try to reduce the synthesizing process time by means of, for example, skipping a portion of the synthesizing process of both objects that are required in preparing page image data.

In order to shorten this synthesizing process time, ways of shortening the synthesizing process time by means of parallelizing synthesizing processes have been proposed. See Unexamined Japanese Patent Publication No. 2002-24813 and 2006-331191.

In parallelizing the synthesizing process, no problem occurs in printing results when the order of synthesis changes if an object is not overlapping with other objects; however, if the object is overlapped with other objects, any change in the order of synthesis results in an image where the objects are synthesized in a wrong order.

In order to cope with the problem, Unexamined Japanese Patent Publication No. 2002-24813 discloses a high speed processing technique by prioritizing the process of overlapped objects so that parallelizing in the latter steps can be simplified. However, this technique prevents parallel processing to be done until the process of overlapped objects is completed, so that it causes a problem that shortening of synthesizing process time cannot be achieved fully in case of print data with lots of overlapping objects.

Further, Unexamined Japanese Patent Publication No. 2006-331191 discloses a technique of grouping a plurality of overlapping objects, and assigning a plurality of image processing processors group by group for the parallel processing. In the particular technique, a plurality of groups is assigned to a plurality of image processing processors in order. However, since the time required for synthesizing process varies from one group to another, the load on each image processing processor varies thus resulting in an insufficient shortening of synthesizing process time by parallelization.

### SUMMARY

It is an object of the present invention to provide an image processing method, a computer readable recording medium stored with an image processing program, and an image processing apparatus, all of which are improved to solve at least one of the abovementioned problems.

It is another object of the present invention to provide an image processing method, a computer readable recording medium stored with an image processing program, and an image processing apparatus capable of more efficiently parallelizing the synthesizing process required for preparing page image data so that the synthesizing process time can be shortened.

To achieve at least one of the abovementioned objects, an image processing method reflecting one aspect of the present invention used on an image processing apparatus having a plurality of processing units for processing print data containing a plurality of objects defining page contents, comprises: (a) grouping said plurality of objects into one group for overlapping objects one of which overlaps with another object among the overlapping objects, and another group for independent object which does not overlap with another object; (b) calculating a drawing area for each of the groups obtained by the grouping process in said step (a); and (c) distributing said plurality of groups into the number of parallel processes to be executed by said plurality of processing units based on the drawing area of each group calculated in said step (b).

In the abovementioned image processing method, it is preferable that a distributing process is executed in said step (c) in such a way as to minimize the difference between the total drawing areas of the distributing destinations.

In the abovementioned image processing method, it is preferable that said print data is described in PPML (Personalized Print Markup Language) or PPML/VDX (PPML/Variable Data Exchange), which is a variable print language.

In the abovementioned image processing method, it is preferable that in said step (b), the drawing area is calculated using layout information containing the sizes and locations of rectangular areas of objects located on a page contained in said print data.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is an overall constitutional diagram of the printing system according to a first embodiment of the invention.

FIG. 2 is a block diagram showing the general constitution of a client terminal.

FIG. 3 is a block diagram showing the general constitution of a printer controller.

FIG. 4 is a diagram for describing a grouping unit, a scheduler, a raster image generating unit, and an image synthesizing unit.

FIG. 5 is a diagram for describing pseudo-synthesized image data, page image data, reuse data, and non-reuse data.

FIG. 6 is a diagram for describing print data.

FIG. 7 is a block diagram showing the general constitution of a printer.

FIG. 8 is a flowchart showing the process sequence on the printer controller.

FIG. 9 is a flowchart showing the process procedure of grouping of objects.

FIG. 10 is a flowchart showing the sequence of the preparing process for the pseudo-synthesized image data.

FIG. 11 is a flowchart showing the procedure of the group classification process.

FIG. 12 is a flow chart, continuing from FIG. 11, showing the group classification process procedure.

FIG. 13 is a flowchart showing the process procedure of deciding a processing order of each group.

FIG. 14 is a flowchart, continuing from FIG. 13, showing the process procedure of deciding a processing order of each group.

FIG. 15 is a diagram for describing the grouping of objects on a page.

FIG. 16 is a diagram showing an example of a raster image data group generated by rasterizing a variable object group.

FIG. 17 is a diagram showing an example of page image data prepared by a synthesizing process.

FIG. 18 shows an example of layout information (of a single page portion).

FIG. 19 is an example of layout information (of a single page portion) after an object name has been changed to appearance order number.

FIG. 20 is a diagram showing a single page portion of pseudo-synthesized image data prepared based on the layout information of FIG. 19.

FIG. 21 is a diagram showing a result of a group classifying process based on the pseudo-synthesized image data of FIG. 20.

FIG. 22 is a diagram showing layout information rearranged group by group based on the result of the group classifying process of FIG. 21.

FIG. 23 is layout information in which object names are returned to original names, and page image data prepared by synthesizing raster image data in a parallel manner based on the particular layout information.

FIG. 24 is a diagram showing an example of pseudo-synthesized image data.

FIG. 25 shows an example of the group table.

FIG. 26 shows an example of the group constitution.

FIG. 27 is a diagram showing another example of pseudo-synthesized image data.

FIG. 28 shows another example of the group table.

FIG. 29 shows another example of the group constitution.

FIG. 30 is a flowchart showing the process procedure for splitting background image data on a printer controller according to the fourth embodiment of the invention.

FIG. 31 is a diagram showing a completed example of page image data prepared by synthesizing graphics and characters with the background data.

FIG. 32 is a diagram showing background image data after drawing areas for all groups are cut out.

FIG. 33 is a diagram showing the areas cut out from the background image data.

FIG. 34 is a diagram showing an example of the mask.

FIG. 35 is a diagram showing how the background image data is split for groups.

FIG. 36 is a diagram showing an example of the managing list according to the sixth embodiment of the present invention.

FIG. 37 is a diagram showing an example of prepared form data.

### DETAILED DESCRIPTION

The embodiment of this invention will be described below with reference to the accompanying drawings.

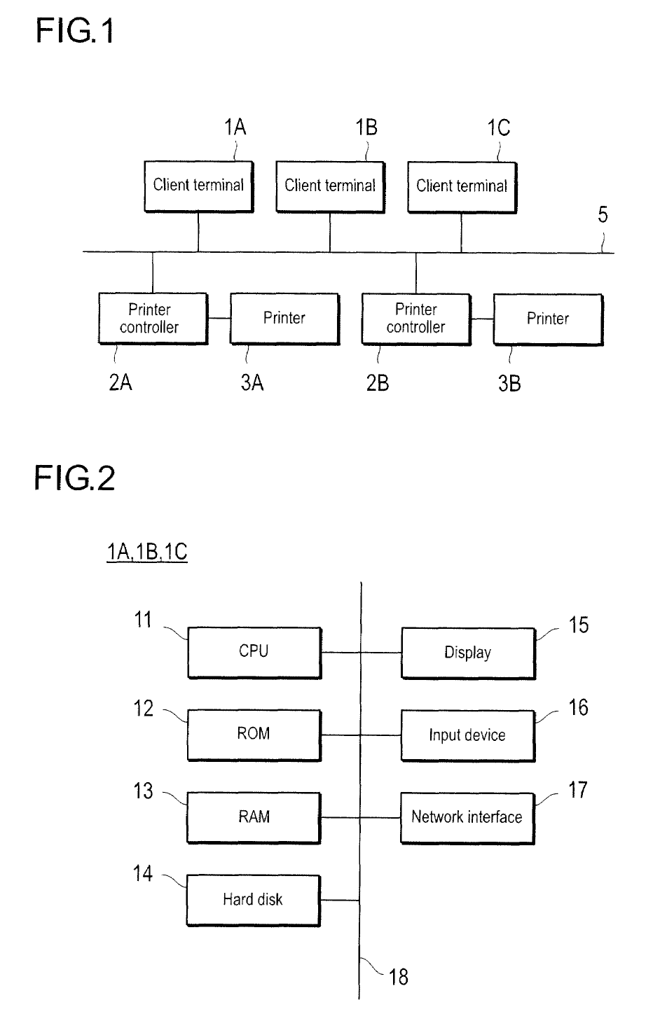

FIG. 1 is an overall constitutional diagram of the printing system according to a first embodiment of the invention. The printing system is equipped with client terminals 1A, 1B, and 1C; printer controllers 2A and 2B as image processing apparatuses; and printers 3A and 3B as image forming apparatuses.

The client terminals 1A, 1B, and 1C and the printer controllers 2A and 2B are interconnected with each other via a network 5 to be communicable with each other. The network can be a LAN connecting computers and network equipment according to standards such as Ethernet®, Token Ring, and FDDI, or a WAN that consists of several LANs connected by a dedicated line. The printer controllers 2A and 2B and the printers 3A and 3B are connected respectively via dedicated interface buses such as IEEE 1394 serial bus, USB (Universal Serial Bus), etc. However, a printer controller and a printer can be connected via the network 5 as well. The types and the number of equipment to be connected to the network 5 are not limited to those shown in FIG. 1.

Next, constitution of each device mentioned above will be described below, but the description of a function common to multiple devices will be made only once when it first appears and will not be repeated afterwards in order to avoid duplicate descriptions.

FIG. 2 is a block diagram showing the general constitution of the client terminals 1A, 1B, and 1C. The client terminals 1A, 1B, and 1C are typically PCs (personal computers). Since the client terminals 1A, 1B, and 1C have identical constitutions with each other, the client terminal 1A shall be used to represent all of them in the following description.

The client terminal 1A contains a CPU 11, a ROM 12, a RAM 13, a hard disk 14, a display 15, an input device 16 and a network interface 17, all of which are interconnected by a bus 18 for exchanging signals.

The CPU 11 controls various parts indicated above and executes various arithmetic processes according to a program. The ROM 12 stores various programs and data. The RAM 13 stores programs and data temporarily as a working area. The hard disk 14 stores various programs including an operating system and data.

The hard disk 14 has a printer driver installed for preparing print data.

The display 15 is typically a LCD, CRT, etc., and displays various kinds of information. The input device 16 includes a pointing device such as a mouse, a keyboard, and others, and is used for executing various kinds of inputs. The network interface 17 is typically a LAN card and is used for communicating with external equipment via the network 5.

The client terminal 1A prepares print data and transmits it to a printer controller. The client terminal 1A is also capable of monitoring the processing conditions at the printer controllers 2A and 2B and displaying images based on page image data prepared in the print controllers 2A and 2B.

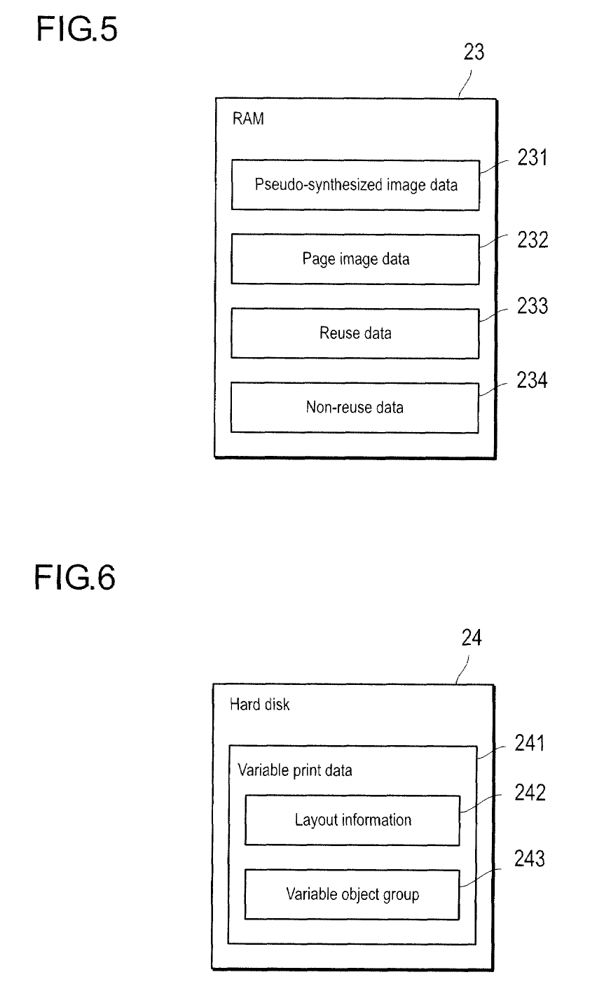

The print data in the present embodiment is preferably a file described in a variable print language such as PPML (Personalized Print Markup Language), PPML/VDX (PPML/Variable Data Exchange). The print data 241 (refer to FIG. 6) is a file which combines a layout file containing layout information 242 of objects on each page (refer to FIG. 6), and a data file containing a data group by object (variable object group 243, refer to FIG. 6). The data file contains reuse objects and non-reuse objects. A reuse object is an object that can be used on one page or repetitively on multiple pages, while a non-reuse object is an object that can be used only once. The layout information of the layout file contains information by object type indicating whether an object is a reuse object or a non-reuse object, information concerning the size of a page, and information indicating the sizes and locations of rectangular areas located on a page. The print data described in a variable print language is more preferable as the calculation of drawing area, which will be described later, can be more speedily and accurately executed by using the information of the size and location of an object in the layout information

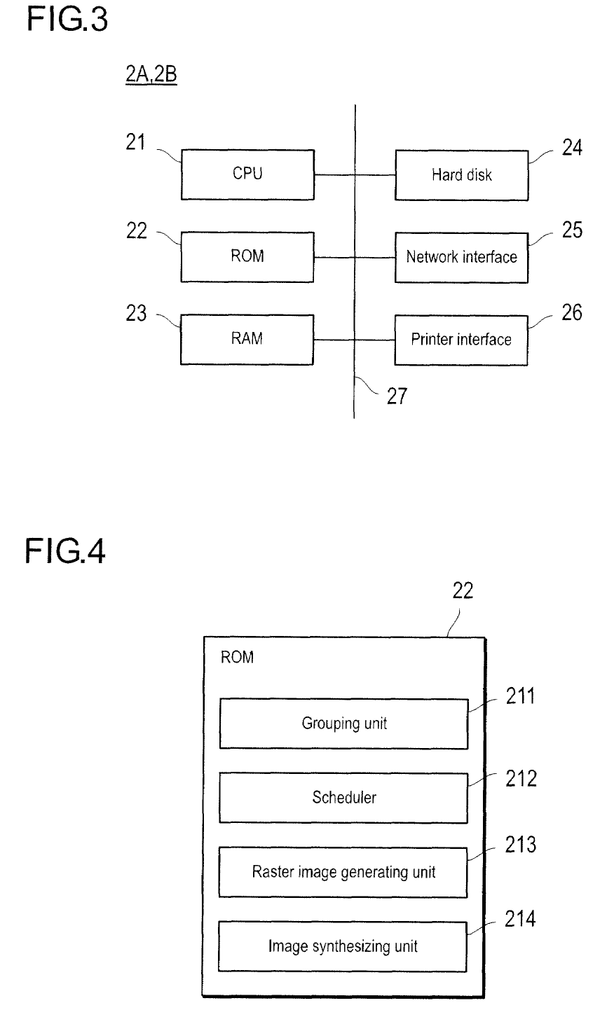

FIG. 3 is a block diagram showing the general constitution of the printer controllers 2A and 2B. Since the printer controllers 2A and 2B have identical constitutions, the printer controller 2A shall be used to represent both in the following description.

The printer controller 2A contains a CPU 21, a ROM 22, a RAM 23, a hard disk 24, a network interface 25, and a printer interface 26, all of which are interconnected via a bus 27 for exchanging signals.

The CPU 21 of the present embodiment has a plurality of processing unit. The process unit here means a processing entity that executes parallel processing in a CPU. However, the processing unit can be an individual CPU of a multi-CPU system.

The printer interface 26 is an interface for communicating with the printer 3A.

As shown in FIG. 4, the ROM 22 provides specific program storage areas for a grouping unit 211, a scheduler 212, a raster image generating unit 213, and an image synthesizing unit 214 for their exclusive uses.

The grouping unit 211 analyzes the description of layout information 242 (refer to FIG. 6, FIG. 18), and groups a plurality of objects into one group for overlapping objects one of which overlaps with another object among the overlapping objects, and another group for independent object which does not overlap with another object.

The scheduler 212 distributes the plurality of groups into the number of parallel processes to be executed by the plurality of processing units based on the drawing area of each group.

The Raster image generating part 213 executes RIP (Raster Image Processing) in order to convert the received print data 241 into image data in a bitmap format. In other words, the Raster image generating part 213 converts the object of the data file contained in the print data into raster image data, i.e., image data of the bit map format to be used by the printer 3A for printing. The raster image data contains reuse data 233 generated by rasterizing reuse objects and non-reuse data 234 generated by rasterizing non-reuse objects (refer to FIG. 5).

The storage period of reuse data 233 is until the preparation of the total page portion of the page image data is completed. However, the storage period is extended when reuse data is used continuously such as in case of reprinting using the print data 241 or in case of processing the print data 241 by splitting into a plurality of parts. Typical non-reuse data 234 are, in case of direct mail printing, customer names, customer addresses, etc. The non-reuse data 234 is erased from the RAM 23 as soon as it is used.

The image synthesizing unit 214 executes image synthesis page by page using the reuse data 233 and the non-reuse data 234 to prepare page image data 232 (refer to FIG. 5).

The functions of the layout file grouping unit 211, the scheduler 212, the raster image generating unit 213, and the image synthesizing unit 214 are implemented as the CPU 21 executes their respective programs. However, all or a portion of these functions can be realized by hardware circuits.

As shown in FIG. 5, the RAM 23 stores pseudo-synthesized image data 231, page image data 232, reuse data 233, and non-reuse data 234.

The pseudo-synthesized image data 231 is image data obtained by drawing with an image pixel value that indicates the synthesizing order number as the identification number of the particular object in the rectangular area in which each object within the page is located. The grouping unit 211 groups a plurality of objects using the pseudo-synthesized image data 231.

As shown in FIG. 6, the hard disk 24 stores the print data 241 received from the client terminal 1A. The print data 241 contains, as described before, the layout information 242 and the variable object group 243.

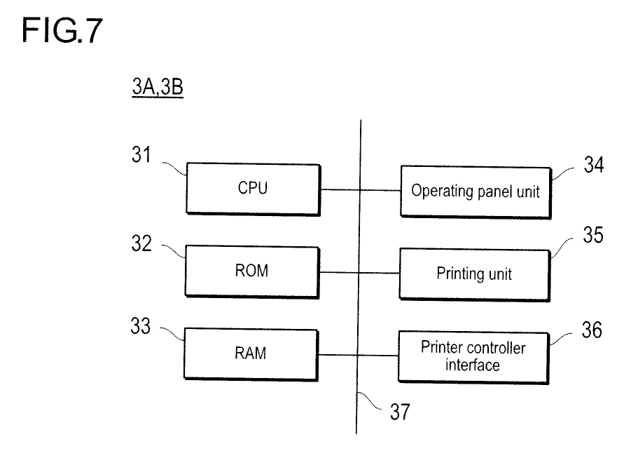

FIG. 7 is a block diagram showing the general constitution of the printers 3A and 3B. Since the printers 3A and 3B have identical constitutions, the printer 3A shall be used to represent both in the following description.

The printer 3A has a CPU 31, a ROM 32, a RAM 33, an operating panel 34, a printing unit 35, and a print controller interface 36, all of which are interconnected with each other via a bus 37 for exchanging signals.

The operating panel unit 34 is used for various information displays and for entering various instructions. The printing unit 35 prints image data on recording media such as paper using a known imaging process such as the electronic photographing process including such processes as electrical charging, exposure, developing, transferring and fixing. The printer controller interface 36 is an interface for communicating with the print server 2A.

The client terminals 1A, 1B, and 1C; the print servers 2A and 2B; and the printers 3A and 3B can contain components other than those components mentioned above, or do not have to contain all of the components mentioned above.

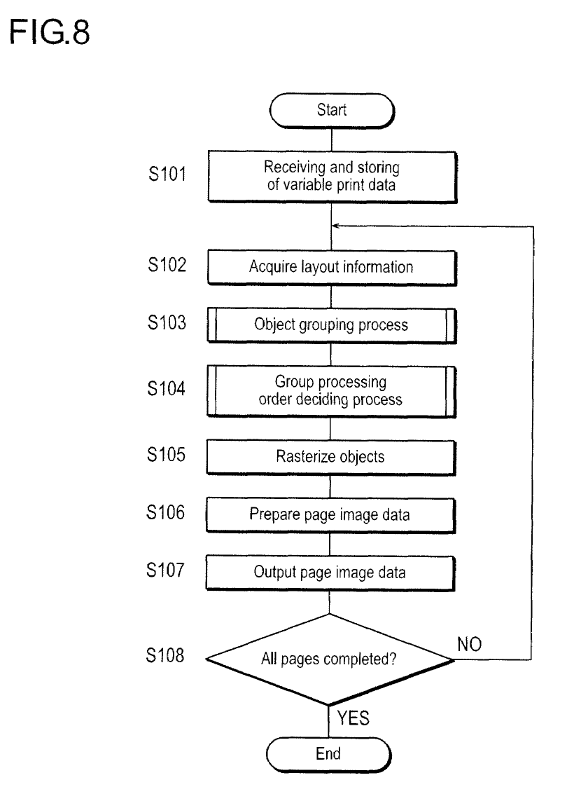

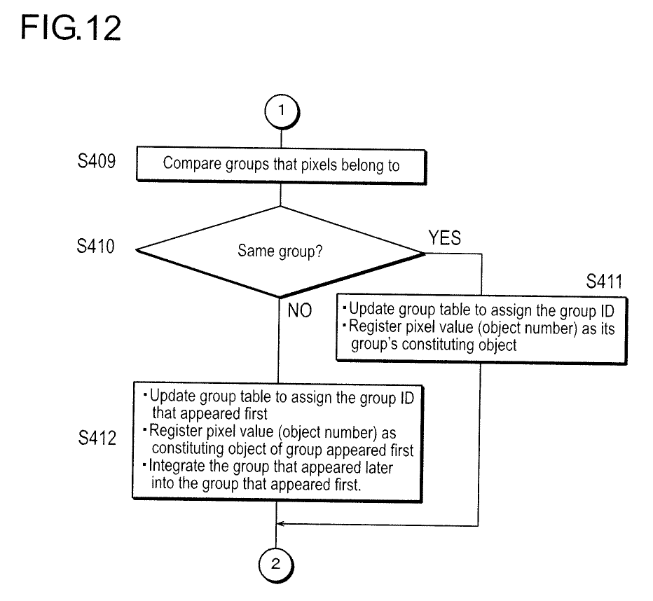

Next, the process in printer controller 2A will be described below referring to FIG. 8 through FIG. 14. The algorithm shown in the flowcharts of FIG. 8 through FIG. 14 is stored as a program in a memory unit such as a ROM 22 of printer controller 2A and executed by CPU 21.

In accordance with the user's operation, the client terminal 1A prepares the print data 241 for executing the variable print and transmits the particular print data 241 to the printer controller 2A.

The printer controller 2A receives the print data 241 from the client terminal 1A and stores the received print data 241 into the hard disk 24 (S101). However, the received print data 241 can be stored in the remote database server or a common file system.

As mentioned before, the print data 241 contains a layout file and a data file. A data file used here can be a file described in a PDL (Page Description Language) such as PS (PostScript®), PDF (Portable Document Format), and EPS (Encapsulated PostScript). However, a data file can also consist of other type of data such as RIP-processed data and vector data.

Next, the CPU 21 of the printer controller 2A acquires the layout information 242 from the print data 241 (S102). The layout information 242 is passed on to the grouping unit 211.

The grouping unit 211 executes the grouping process of the object based on the layout information 242 (S103). In other words, the grouping unit 211 groups a plurality of objects into two groups, one group of overlapping objects and another group of non-overlapping individual objects. The detail of the grouping process of objects will be discussed later.

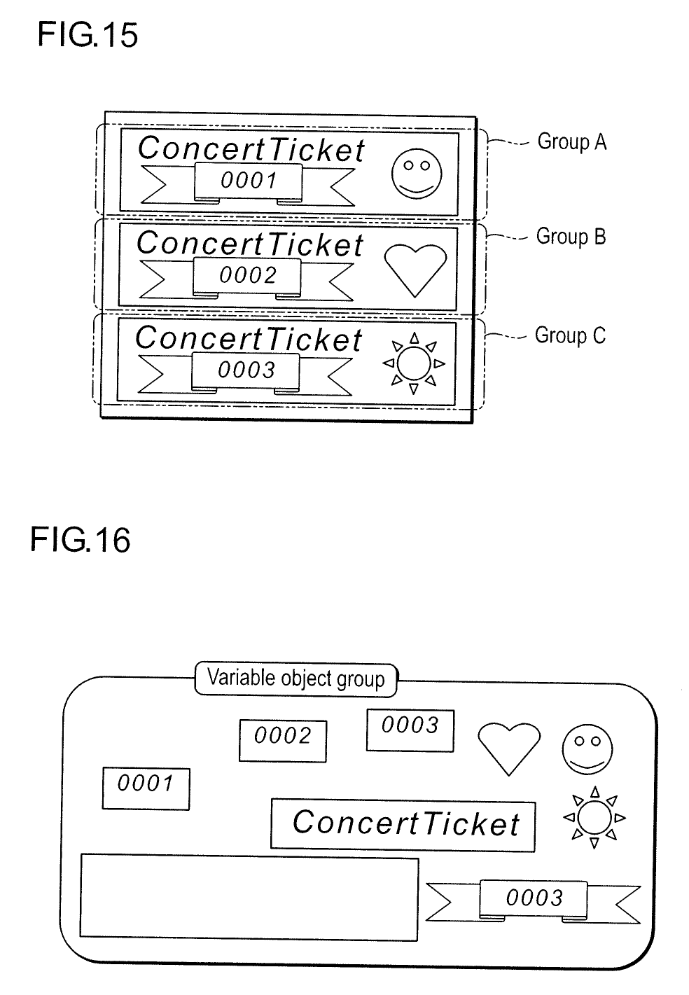

FIG. 15 is a diagram for describing the grouping of objects on a page. In case of FIG. 15, a plurality of objects contained in one page is divided into three groups, A-C.

After the grouping process, the process of deciding the order of process within each group (scheduling) is performed (S104). In other words, the scheduler 212 calculated the drawing area for each of the groups obtained by the grouping process. The scheduler 212 distributes the plurality of groups into the number of parallel processes to be executed by the plurality of processing units based on the drawing area of each group. The detail of the process of deciding the order of process within each group is described later. The result of the scheduling is reflected on the layout information 242 stored in the RAM 23.

After the scheduling, the raster image generating unit 213 rasterizes each object of the variable object group 243 with proper resolution to generate raster image data having each color component of CMYK (S105).

FIG. 16 is a diagram showing an example of a raster image data group generated by rasterizing a variable object group. The generated raster image data is stored in the RAM 23 as the reuse data 233 and the non-reuse data 234.

Next, the CPU 21 acquires one page portion of the layout information from the layout information 242 and instructs the image synthesizing unit 214 to prepare one page portion of the page image data. The image synthesizing unit 214 prepares one page portion of the page image data 232 (FIG. 5). by synthesizing the reuse data 233 and non-reuse data 234 based on one page portion of the layout information (S106).

The synthesizing process of preparing the page image data synthesizing the raster image data (S106) is done in parallel by a plurality of processing units for each distribution destination of groups.

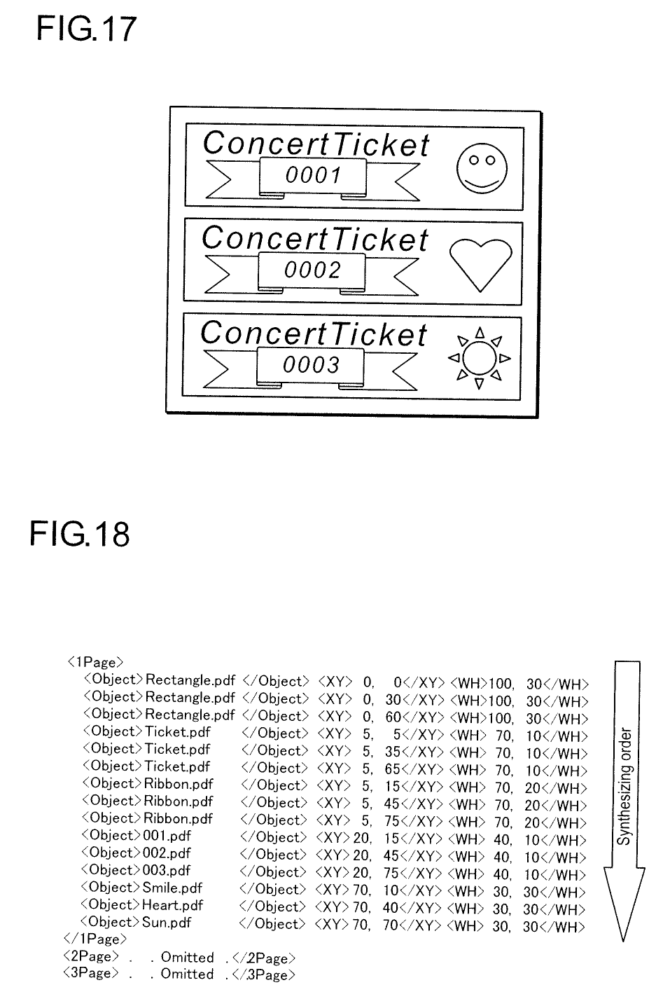

FIG. 17 is a diagram showing an example of page image data generated by a synthesizing process.

The image data thus prepared is outputted for printing to the printer 3A via the printer interface 26 (S107). The printer 3A prints the image based on the page image data on printing paper and applies the finishing process to the printed paper as needed.

In the step S108, a judgment is made as to whether or not the process of all pages of the print data 241 has been completed. If the process of all pages is completed (S108: Yes), the process of FIG. 8 is terminated. On the other hand, if there are any pages left with the process to be completed (S108: No), the program returns to the step S102.

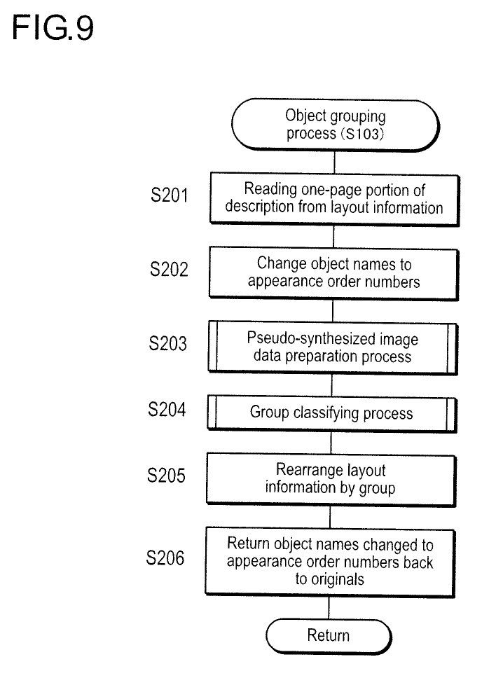

Next, let us describe the object grouping process (S103) with reference to FIG. 9.

The CPU 21 reads one page portion of the description from the layout information 242 (S201).

FIG. 18 shows an example of layout information (of a single page). Layout information 242 contains information about the names, types, sizes (sizes of circumscribed rectangles), and locations (coordinates within a page) of the objects. The sizes and locations of he rectangular areas of the object are expressed by point values. An example shown in FIG. 18 indicates that the object with a name of “Rectangle. pdf” is synthesized at the position (0, 0) with a size of (100×30) on the first page of the print data 241. Although XML-format data is used as layout information in this example, the data format is not to be limited to XML, but data of other formats can be used.

Next, the CPU 21 analyzes one page portion of the description read, and changes the object name to the order number of its appearance (synthesizing order number) (S202).

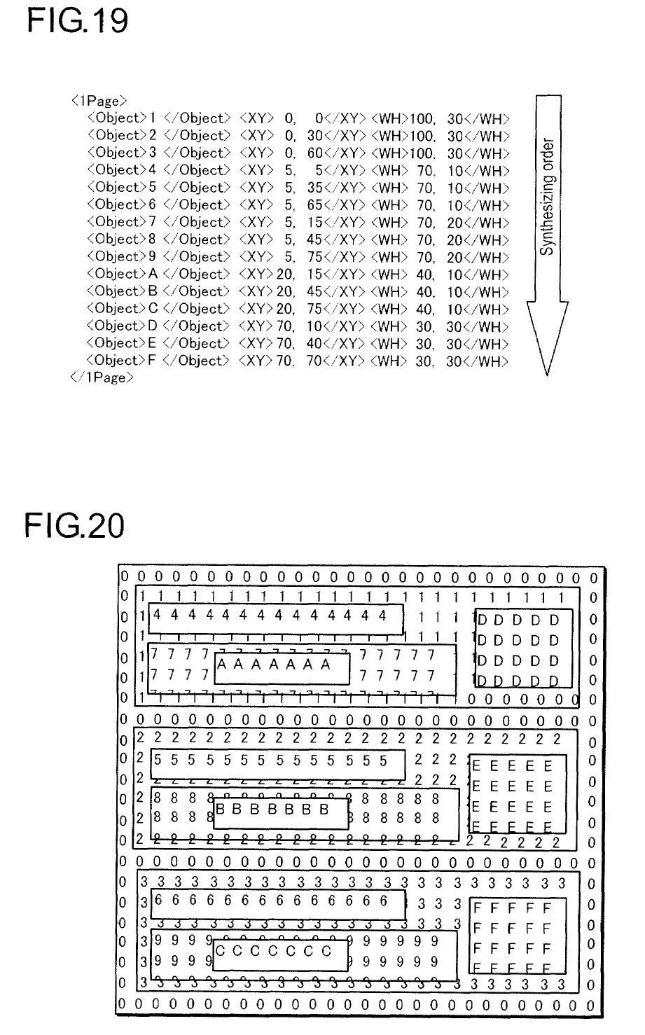

FIG. 19 is an example of layout information (of a single page portion) after an object name has been changed to appearance order number.

Next, the pseudo-synthesized image data preparation process is executed using the layout information after the change (S203). In other words, the CPU 21 draws with the pixel value representing the appearance order number as the identification number of the particular object in the rectangular area in which each object within the page is located to prepare one page portion of the pseudo synthesized image data 231.

FIG. 20 is a diagram showing a single page portion of pseudo-synthesized image data prepared based on the layout information of FIG. 19.

At this time, the raster image data acquired by rasterizing the variable object group 243 is not required. The object number (appearance order number) is used as the pixel value for drawing the rectangle. If the number of objects contained within one page is less than 256, the pseudo-synthesized image data 231 can be prepared as gray scale image data where each pixel has 8 bit information. On the other hand, if the number of objects contained within one page is less than 257, the pseudo-synthesized image data 231 can be prepared as color image data having, for example, each color component of RGB. Since the pseudo-synthesized image data 231 is formed in low resolution, only a small amount of processing time, memory, and CPU capacity is required. The detail of the pseudo-synthesized image data preparation process will be described later.

Next, the group classification process using the prepared pseudo-synthesized image data is executed (S204). In other words, the CPU 21 reads the prepared pseudo-synthesized image data 231 (refer to FIG. 20) one pixel at a time, makes an overlapping judgment of the rectangular area of each object to group the objects.

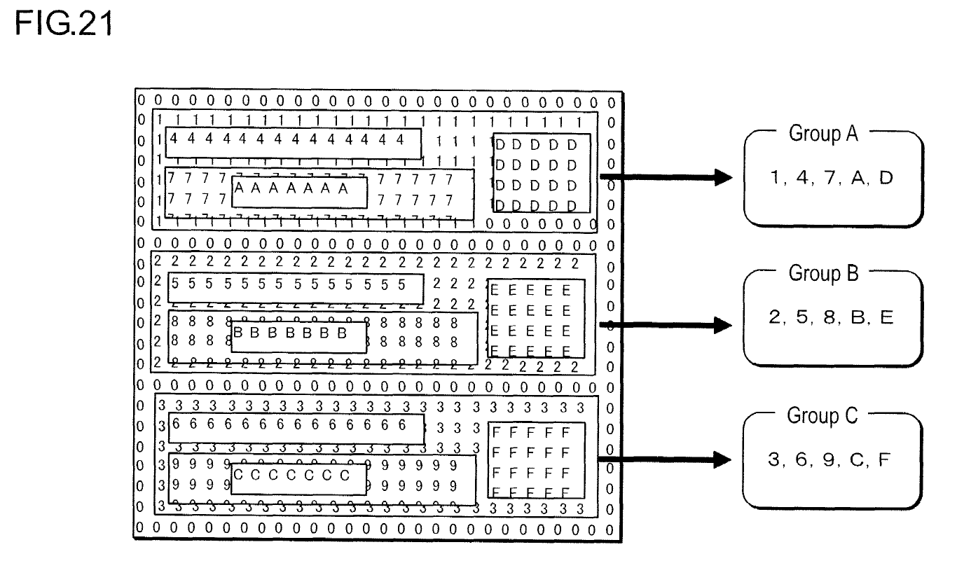

FIG. 21 is a diagram showing a result of a group classifying process based on the pseudo-synthesized image data of FIG. 20. As shown in FIG. 21, the objects with object numbers (appearance order numbers) of “1, 4, 7, A and D” are grouped as Group A, those with object numbers (appearance order numbers) of “2, 5, 8, B and E” are grouped as Group B, and those with object numbers (appearance order numbers) of “3, 6, 9, C and F” are grouped as Group C. The detail of the classification process will be described later.

After the group classifying process is completed, the layout information is rearranged for each classified group (S205).

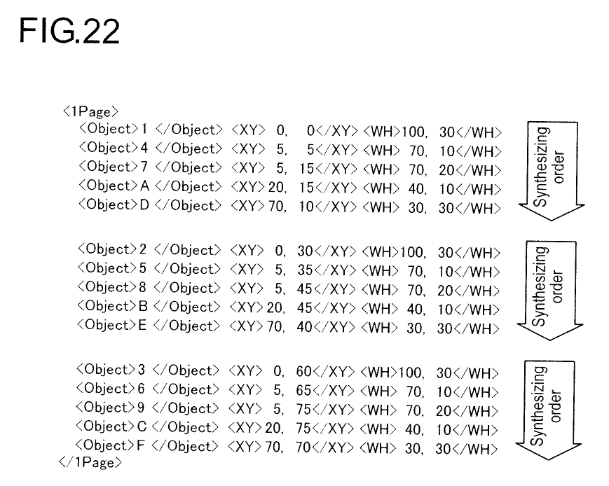

FIG. 22 is a diagram showing layout information rearranged by group based on the result of the group classifying process of FIG. 21.

The CPU 21 returns the object name change to the appearance order number in the layout information, which is rearranged for each group, to the original object name (S206).

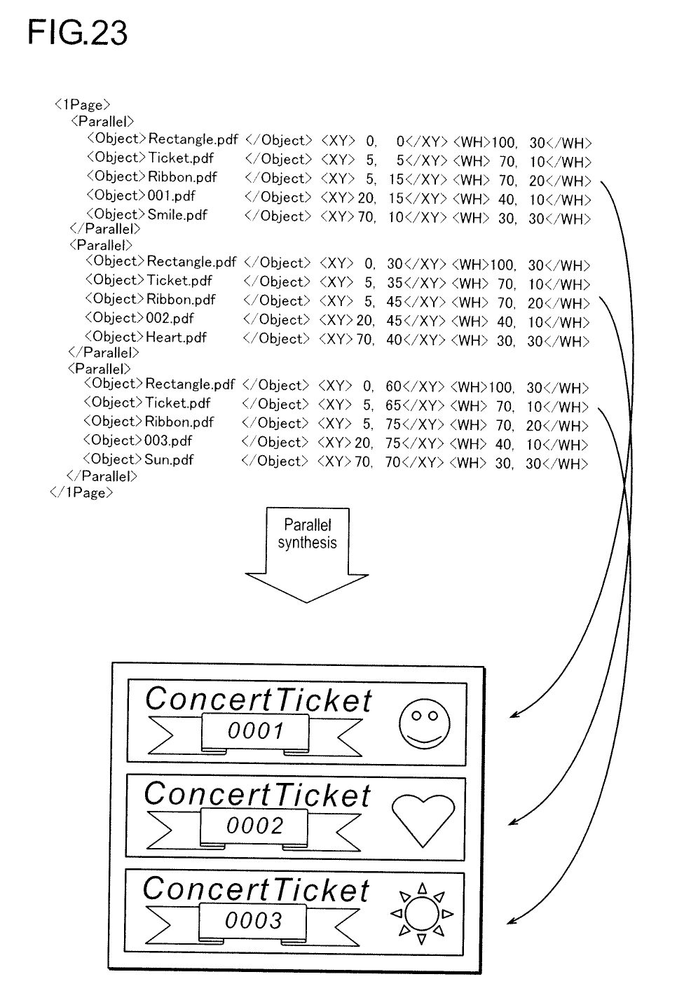

FIG. 23 is layout information in which object names are returned to original names, and page image data prepared by synthesizing raster image data in a parallel manner based on the particular layout information.

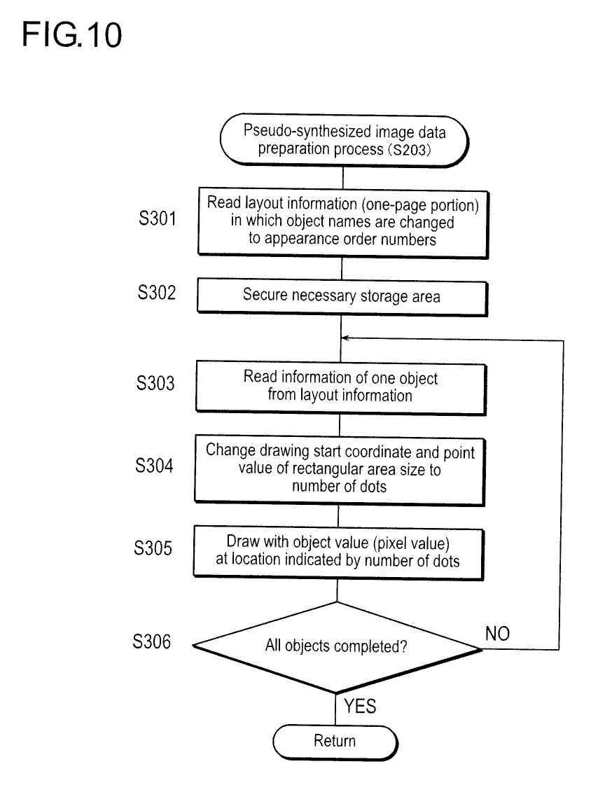

Next, let us describe the procedure of the pseudo-synthesized image data preparation process (S203) with reference to FIG. 10.

First, the CPU 21 reads the layout information (one page portion, refer to FIG. 19) after the object name is changed to the appearance order number (S301).

Next, the necessary storage area is secured in the RAM 23. In other words, the CPU 21 calculated one page portion of the image size from the page size (size of one page, A4, etc.) to secure the storage area.

The CPU 21 reads the information of one object from the layout information (S303).

Next, the drawing start coordinate of the particular object and the point value of the rectangular area size are changed to number of dots (S304).

In general, the size of a file described in a page description language or a variable print language is the point value. However, the number of dots is used for raster image data. Therefore, it is necessary to convert from points to dots.

The following is the conversion formula:

Number of dots=point value×resolution (dpi)/72.

Incidentally, 1 point= 1/72 inch.

Next, the CPU 21 draws a rectangle in a storage area secured in step S302 by placing an object value (pixel value) at the location indicated by the number of dots (S305).

In the step S306, a judgment is made as to whether or not the processes of all objects of the page have been completed. If the processes of all objects are completed (S306: Yes), the process of FIG. 10 is terminated. On the other hand, if there are any objects left with the process to be completed (S306: No), the program returns to the step S303.

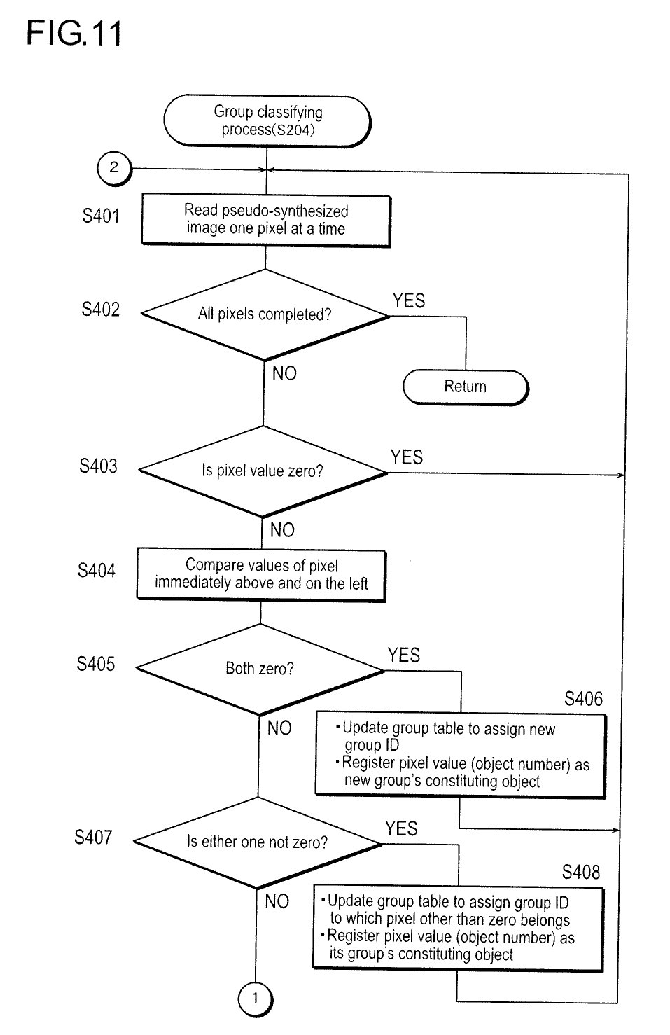

Next, the grouping classifying process (S204) will be described below referring to FIG. 11.

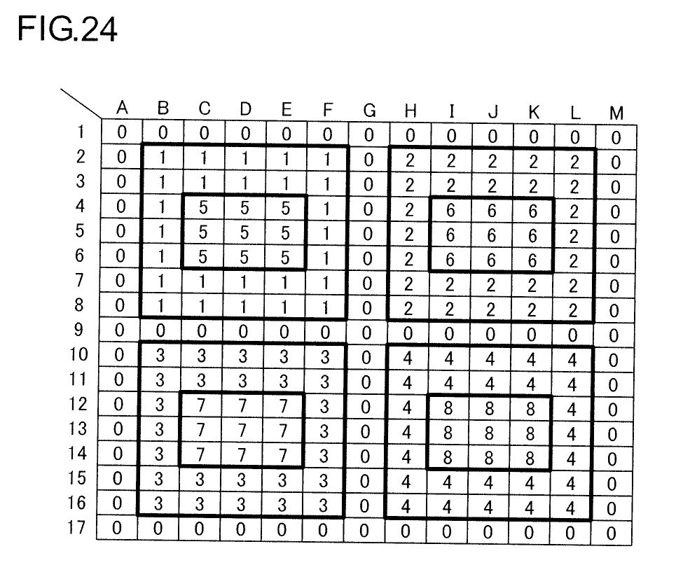

For the sake of easy understanding, let us describe the group classification process first using the pseudo-synthesized image data of FIG. 24. The page shown in FIG. 24 consists of eight objects. In FIG. 24, the image data is formed by drawing with pixel values representing numbers from 1 to 8 in the order of appearance of the objects described in the layout information 242. One can see from FIG. 24 that the object “5” is overlapping the object “1.” Similarly, objects “2” and “6,” objects “3” and “7,” and objects “4” and “8” are overlapping with each other. Let us now describe the group classifying process using the example of FIG. 24.

First, the CPU 21 reads the pseudo-synthesized data pixel by pixel starting from the top left corner (coordinate A1) for FIG. 24 in the left/right direction (S401).

In step S402, a judgment is made as to whether the processing for all pixels is completed or not. If the processes of all pixels are completed (S402: Yes), the process of FIG. 11 is terminated. On the other hand, if there are any pixels left with the process to be completed (S402: No), the program advances to the step S403.

In step S403, a judgment is made as to whether or not the read pixel is zero. When the pixel value is zero (S403: Yes), the program returns to step S401.

If the pixel read is not zero (S403: No, coordinate B2 in FIG. 24), the values of the pixel on the previous row and the same column, i.e., the one immediately above (coordinate B1 in FIG. 24), and the pixel on the left (coordinate A2 in FIG. 24) are compared (S404).

In step S405, a judgment is made as to whether or not the values of both pixels are zero as a result of step S404.

If the values of both pixels are zero (S405: Yes), the CPU 21 determines that they are pixels of the new group and updates the group table to assign the new group ID to the particular pixel (S406).

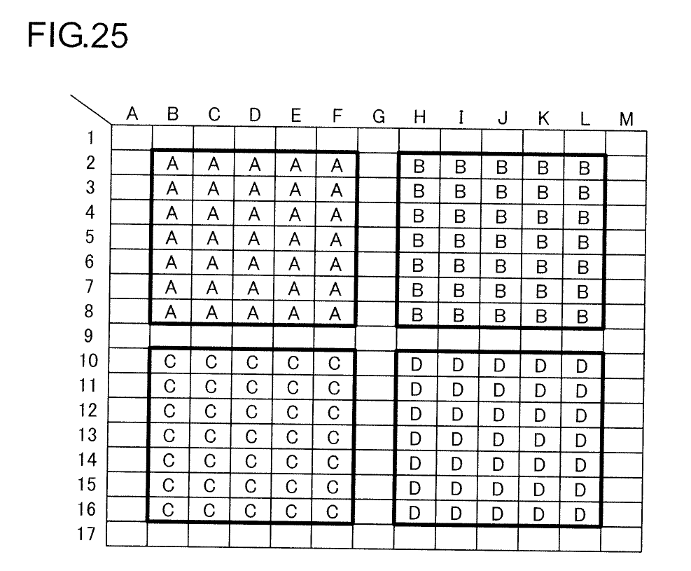

FIG. 25 shows an example of group table. As shown in FIG. 25, (A) is assigned as the new group ID to the pixel at the coordinate B2.

In step S406, the CPU 21 registers the pixel value (object number) as the constitutional object of the new group.

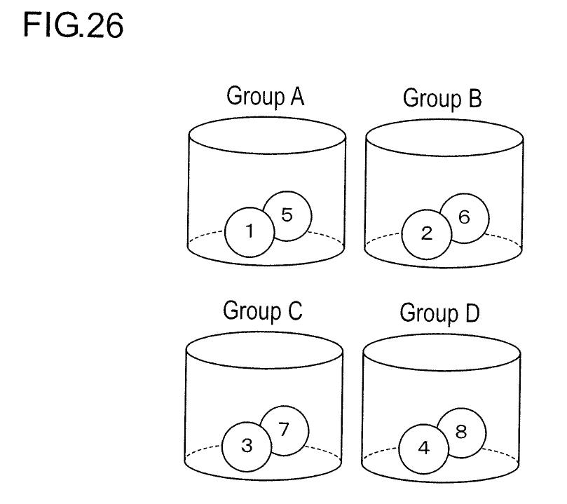

FIG. 26 shows an example of group constitution. As shown in FIG. 26, the pixel value (object number) “1” is registered as the constitutional object of the new group A.

After the process of step S406 is completed, the program returns to step S401.

If, in step S405, at least one of the two pixels is determined to be not zero (S405: No), the program advances to step S407.

In step S407, a judgment is made as to whether one of the values of the two pixels is other than zero or not as a result of step S404.

If only one of the values of the two pixels is other than zero (S407: Yes), the CPU 21 updates the group table in order to assign to the particular pixel the group ID to which the pixel other than zero belongs (S408). As shown in FIG. 25, (A), which is the group ID on the left, is assigned as the group ID to the pixel at the coordinate C2.

In step S408, the CPU 21 registers the pixel value (object number) as the constitutional object of the particular group. As shown in FIG. 26, the object number “1” is already registered so that duplication of registration is avoided.

After the process of step S408 is completed, the program returns to step S401.

Similar assignment of the group ID and registration of the object number are repeated for the pixels at coordinates D2 through F2 of FIG. 24. The CPU 21 judges that the pixel at the coordinate H2 shown in FIG. 24 is a pixel of a new group as the values of the pixel immediately above it and the pixel on the left are both zero (S405: Yes), and updates the group table by assigning, for example, (B) to the particular pixel as the new group ID. Also, the CPU 21 registers the pixel value (object number) “2” as the constituting object of the new group B (see S406, FIG. 25, FIG. 26). Similar assignment of the group ID and registration of the object number are repeated for the pixels at the coordinates I2 through L2 of FIG. 24. Since the pixel of the previous row and the same column, i.e., the pixel immediately above (coordinate B2 of FIG. 24) is not zero, the pixel of the coordinate B3 shown in FIG. 24 is assigned with (A), which is the group ID immediately above, as the group ID. Incidentally, the object number “1” is already registered so that duplication of registration is avoided.

If, in step S407, the values of the two pixels are both determined to be not zero (S407: No), the program advances to step S409.

In step S409, the group to which the pixel immediately above and the group to which the pixel on the left are compared.

In step S410, a judgment is made as to whether the two groups are the same or not as a result of step S409.

If the two groups are the same (S410: Yes), the CPU 21 updates the group table to assign the group ID to the particular pixel (S411). As shown in FIG. 25, (A), which is the group ID of the pixels immediately above and on the left, is assigned as the group ID to the pixel of the coordinate C3.

In step S411, the CPU 21 registers the pixel value (object number) as the constitutional object of the particular group. As shown in FIG. 26, the pixel value “5” is registered as the constitutional object of the new group A.

After the process of step S411 is completed, the program returns to step S401.

If, in step S410, the two groups are determined to be not the same (S410: No), the program advances to step S412.

In the group classification process using the pseudo-synthesized image data of FIG. 24, the case, in which the two groups are judged as not identical instep S410 (S410: No), does not exist.

As the above procedure is executed for all the pixels, the grouping of the object as shown in FIG. 26 is possible. As shown in FIG. 26, the objects “1” through “8” are classified into four groups.

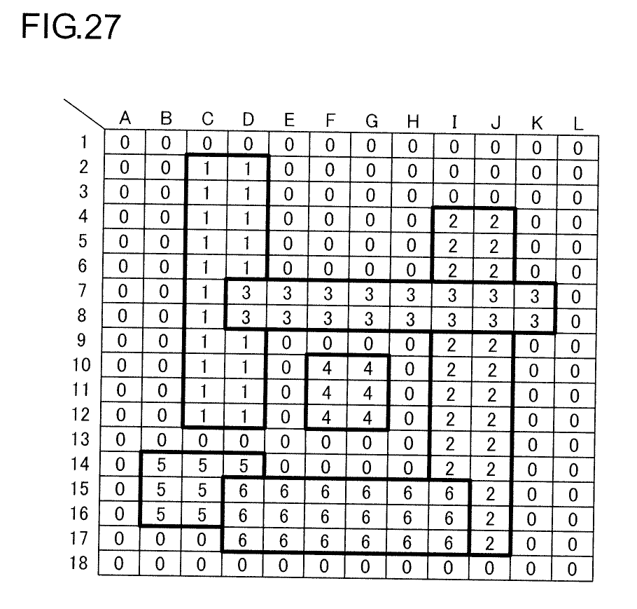

Next, let us describe the group classification process using the pseudo-synthesized image data of FIG. 27.

FIG. 27 is a diagram showing an example of the pseudo-synthesized data when the reliance relation between the objects was made more complex. The page shown in FIG. 27 consists of six objects.

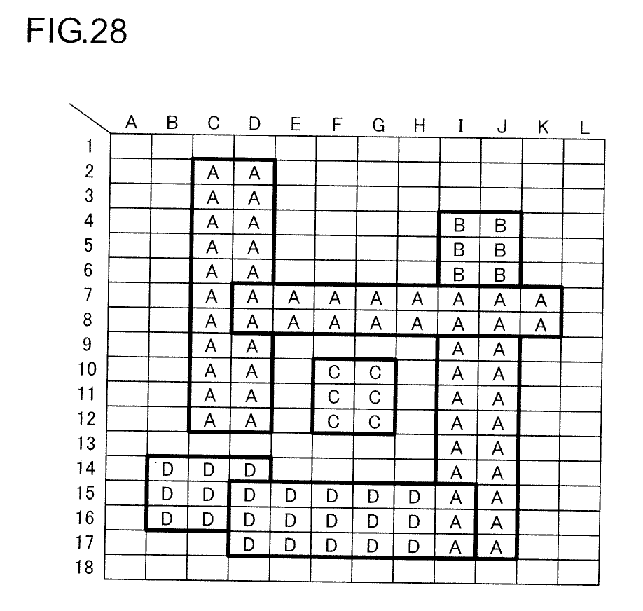

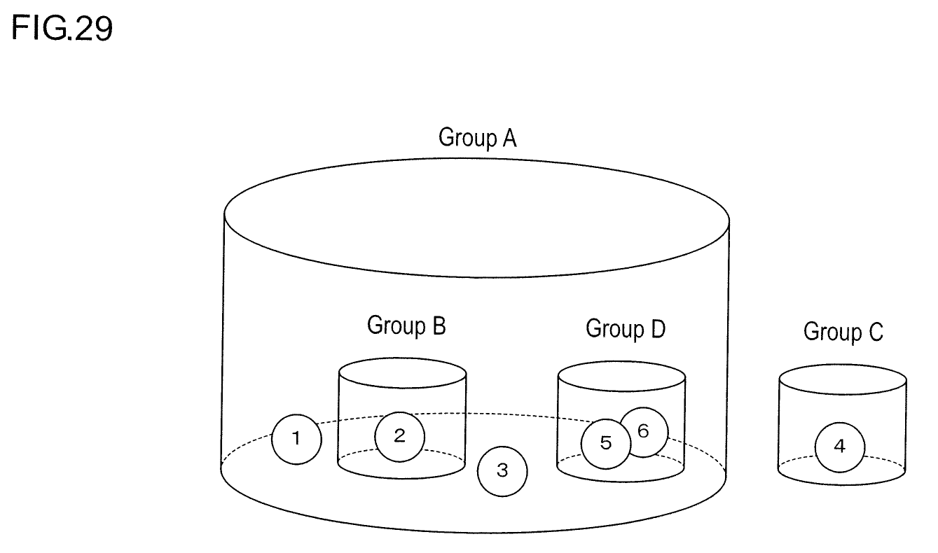

The process similar to the process described using FIG. 24 is implemented up to the pixel at the coordinate H7 of FIG. 27. As shown in the group table of FIG. 28, (A) and (B) appear as the group IDs by processing up to the pixel at the coordinate H7. Also, as shown in the diagram of FIG. 29 indicating the group constitutions, the constituting objects of the group A are “1” and “3,” while the constituting object of the group B is “2.”

In processing the pixel at the coordinate I7 of FIG. 27, a case exists wherein the group to which the pixel immediately above belongs is judged to be different from the group to which the left pixel belongs (S410: No).

In this case, the CPU 21 updates the group table to assign the group ID that appeared first to the particular pixel (S412). As shown in FIG. 25, (A), which appeared first as the group ID of the pixel on the left, is inherited and assigned as the group ID to the pixel at the coordinate I7, for example.

In step S412, the CPU 21 registers the pixel value (object number) as the constitutional object of the particular group that appeared first. As shown in FIG. 29, the pixel value “3” is registered as the constitutional object of the new group A. Furthermore, the group that appeared later is integrated into the group that appeared first. In this case, the group B is integrated into the group A as shown in FIG. 29.

After the process of step S412 is completed, the program returns to step S401.

A similar process is executed in the processing of the pixel at the coordinate I15 of FIG. 27. In other words, as shown in FIG. 28, (A), which appeared first as the group ID of the pixel immediately above, is inherited and assigned as the group ID to the pixel at the coordinate I15. Also, as shown in FIG. 29, the group D that appeared later is integrated into the group A which appeared first.

As the above procedure is executed for all the pixels, the grouping of the object as shown in FIG. 29 is accomplished. As shown in FIG. 29, the objects “1” through “6” are classified into two groups as a result. In other words, the numbers of the objects that belong to the group A are “1, 2, 3, 5, and 6.” The number of the object that belongs to the group C is “4.”

Those are the descriptions of the group classification process using the two pseudo-synthesized images. The abovementioned group classification process does not function well from the theoretical standpoint because the pixel immediately above and the pixel on the left are always zero in case the object is a one-dimensional (one pixel) slanted line. However, in case of a description based on a variable print language, even if the object is a one-dimensional (one pixel) slanted line, its layout information is expressed as a two-dimensional rectangular area having a width, a height and a rotational angle. Therefore, there is no chance of the pixel immediately above and the pixel on the left being always zero, so that there is no chance of causing an error in the group classification process described above.

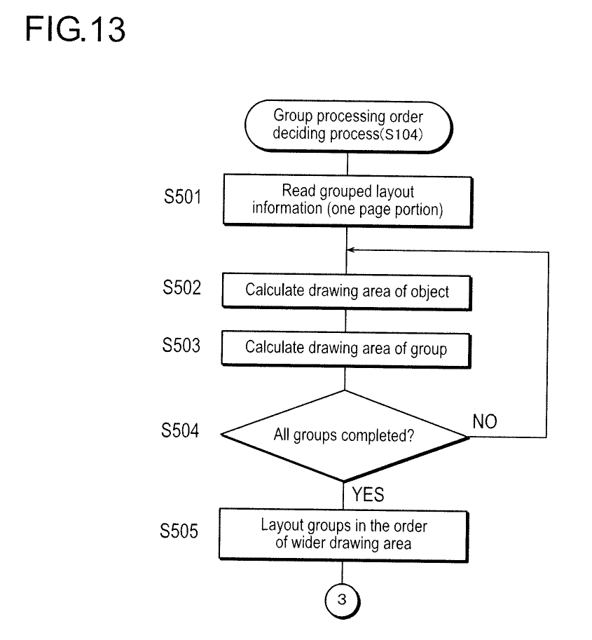

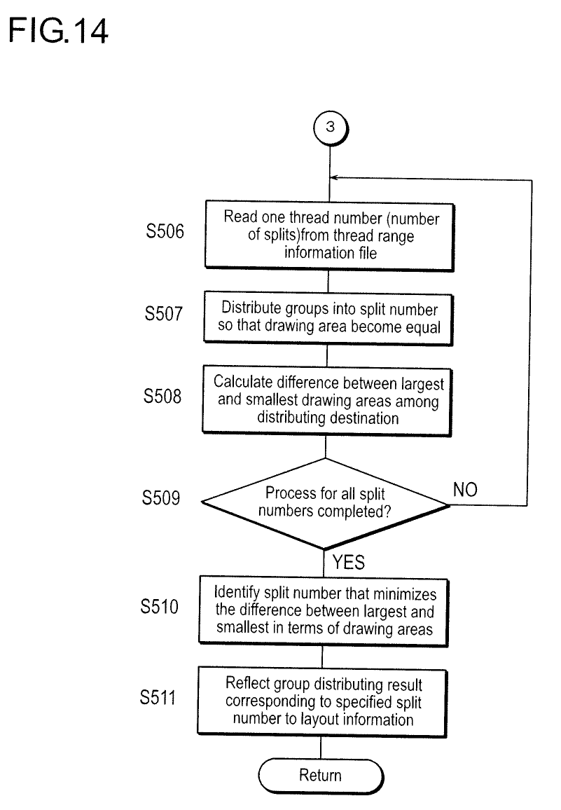

Let us now describe the group processing order determination process (scheduling: S104) with reference to FIG. 13 and FIG. 14.

In case where the usage rate of the CPU for one task reaches 100%, further time saving is not achievable because there is no room left for the CPU to process other tasks even if the particular task is split, parallelized or multi-threaded. However, the CPU usage rate is not so high in the image forming process (rasterizing process and synthesizing process) as the majority of the usages is the memory access for a large amount of data. Therefore, it is possible to shorten the processing time by splitting the task into a proper granularity (size, number) and parallelizing the task. The task here means a one-page portion of the image forming process (rasterizing process and synthesizing process).

In order to find a number of threads (paralleling number) appropriate for shortening the process time, two procedures are needed. The first procedure is to find the optimum number of threads according to the features of the task to be processed and the characteristics of the hardware. The features of the hardware include the specifications of the CPUs, the number of the CPUs, and the specifications of the memory bus. The features of the task to be processed include the tasks that consume the CPU(s), the tasks that consume the memory, and the tasks that consume both the CPU(s) and the memory. Generally speaking, the method of finding the optimum number of threads (paralleling number) is to identify the range of shortening of the process time (e.g., 4-8 threads) executing the process while increasing the number of threads of the task (image forming process) on the targeted hardware. Since the range of the number of threads does not vary in executing the same type of tasks (e.g., image forming process and arithmetic process), measuring only once when the hardware is decided suffices the purpose. The result of the measurement is stored as the thread range information file in an external storage device such as the hard disk 24. The second procedure is to find the number of splitting that facilitates the most equalized splitting within the range of the number of threads identified in the first procedure. The equalization of the task in the image forming process means the equalization of the drawing areas. Since the number of splits that provides equalization varies with the features of the page image data, the splitting number detection process is executed for each print data (job) or page.

The procedure of the splitting number detection process will be described below using the flowcharts of FIG. 13 and FIG. 14.

First, the CPU 21 reads the layout information (one-page portion) for which the grouping process is completed (S501).

Next, the drawing area is calculated for each object (S502). In other words, the CPU 21 calculates the number of points of each object as the drawing area based on the size of the rectangular area of each project described in the layout information.

Next, the drawing area is calculated for each object (S503). In other words, the CPU 21 calculates the sum of the drawing areas for each group to which each object belongs.

In the step S504, a judgment is made as to whether or not the drawing care calculations for all groups are completed. If the drawing calculations for all groups are completed (S504: Yes), it id judged that the calculation for one page is completed and the program advances to the step S505. On the other hand, if there are any groups left with the drawing area calculation to be completed (S504: No), the program returns to the step S502.

In step S505, the groups are laid out in the order of largeness of the drawing area.

Next, the CPU 21 reads one of the numbers of threads (number of splits) from the thread range information file (S506).

The CPU 21 then distributes the groups into the number of splits in such a way that the drawing areas are equal (S507). For example, if the drawing areas of the groups arranged in step S505 are (9, 8, 7, 6, 5, 4, 3, 2, 1), it can be split into four groups, (9, 2, 1), (8, 3), (7, 4) and (6, 5).

Next, the CPU 21 calculates the difference between the largest drawing areas and the smallest drawing areas among the distributing destinations (S508). In case of the four groupings shown above, the largest drawing area is 12 and the smallest drawing area is 11, so that the difference is 1. In splitting into five groups, the result is (9), (8, 1), (7, 2), (6, 3), and (5, 4). Since the largest drawing area is 9 and the smallest is also 9, the difference is zero.

In step S509, a judgment is made as to whether the processing for all split numbers is completed or not. If the process for all the split numbers is completed (S509: yes), the program advances to step S510. On the other hand, if there are any split numbers left with the process to be completed (S509: No), the program returns to the step S506.

In step S510, the CPU 21 identifies the number of splits that produce the smallest difference between the largest drawing area and the smallest drawing area (S510).

As the distributing process is done in such a way as to minimize the difference between the total drawing areas of the distributing destinations as shown in the above, the paralleling effect is optimized. However, the distributing process can be an operation of making the difference between the total drawing areas of the distributing destinations smaller than a certain limit such as 20%. Although the number of points is used as the drawing area in the present embodiment, the drawing area is not limited to this but can be a number of pixels adopted in the grouping process of the objects (step S103), or any other index that can be used for comparing the relative drawing areas between the groups.

Next, the CPU 21 reflects the result of the distributing in correspondence with the number of splits specified in step S510 on the layout information (E211). The result of distributing used here is the result obtained in step S507. More specifically, the description of the layout information is modified in such a way that the objects of the groups belonging to one distributing destination can be described between the tags of <Parallel> and </Parallel> as shown in the layout information of FIG. 23.

As can be seen from the above, the printer controller 2A in the present embodiment is an image processing apparatus having a plurality of processing units and executes a grouping process for grouping a plurality of objects into one group for overlapping objects one of which overlaps with another object among the overlapping objects, and another group for independent object which does not overlap with another object. The printer controller 2A calculates the drawing area for each of the groups obtained in the grouping process, and distributes the groups into the number of parallel processes according to the plurality of processing units based on the calculated drawing area of each group.

Therefore, according to the present embodiment, an efficient parallelization of the synthesizing process required for preparing the page image data can be achieved. This makes it possible to shorten the synthesizing process time and to improve the overall performance of the image forming process.

According to the present embodiment, the printer controller 2A prepares the pseudo-synthesized image data by drawing in a rectangular area within a page where each object is placed using a pixel value indicating the identification number of the particular object, and identifies the overlapping objects and the independent object which does not overlap with another object based on the pixel value of each pixel and the pixel values of pixels adjacent to the particular pixel in the prepared pseudo-synthesized image data. Therefore, since the pseudo-synthesized image data can be formed at low resolution, the processing time and the memory as well as the CPU consumption can be minimized. Also, the time required for grouping of the objects using the pseudo-synthesized image data is constant regardless of the number of the objects that constitute the page, so that a fast processing can be achieved.

Next, the second embodiment of the invention will be described below. The following description focuses on the difference from the embodiment described in the above, and omits the descriptions of areas that are identical to those of the embodiment already described.

In the first embodiment, the grouping process and the scheduling are done for each page. However, it is a common practice that the same layout is repeated cyclically on every page or on every several pages. The same layout here means that the size and location (drawing size and drawing coordinate) are identical within a page although the actual object drawn on each page is different. Therefore, the grouping process and scheduling does not normally have to be executed on each page. Therefore, in the second embodiment, the description of the layout information is compared for each page, and the grouping process and scheduling are implemented only on pages whose layouts are different.

Thus, in the second embodiment, the print data has a plurality of pages. Also, the printer controller 2A as an image processing apparatus compares the layout indicating the sizes and locations of rectangular areas located on a page by each page using the layout information contained in the print data to be processed in order to identify the pages with different layouts. Thus, the printer controller 2A executes the grouping process and the scheduling only on pages where the layout is different.

According to the second embodiment, it is not only possible to achieve the same operating effect as in the embodiment previously described but also possible to shorten the time required for the grouping process and the scheduling so that the performance of the image forming process as a whole can be further improved.

Next, the third embodiment of the invention will be described below. The following description focuses on the difference from the embodiment described in the above, and omits the descriptions of areas that are identical to those of the embodiment already described.

The first embodiment was described assuming a case where object groups are synthesized on a solid background (no background image data). As a result, the pixel values of the background portions were assumed zero in the grouping process (refer to FIG. 20). However, in the variable data print method, it is not rare to see object groups are synthesized on a background data on background data (form data). According to the third embodiment, grouping of objects is possible in such a case as well.

The layout information shown in FIG. 18 is used to describe this as an example. First, the size of the rectangular are of an object described at the head of the page, i.e., the drawing size is obtained. The drawing size of the object at the head of the layout information of FIG. 18 is (100×30). The drawing size (100×30) of this object is compared with the size of the page image data when completed. The size of the page image data when completed, i.e., the size of the page, is described in the layout information. When they are close, this object is judged to be background image data (form data), and the number of this object is set to zero (background image data). Incidentally, in case of the example shown in FIG. 18, the drawing size of the leading object is not close to the size of the page image data, so that it is not considered as the background image data.

As can be seen from the above, the printer controller 2A as the image processing apparatus identifies the background image data based on the comparison between the size of the page and the size of the rectangular area of the object using the layout information included in the print data to be processed in the third embodiment. The printer controller 2A treats the identified background image data as one group.

According to the third embodiment, it is not only possible to achieve the same operating effect as in the embodiments described above, but also possible to implement grouping of objects even when the page has background image data (form data).

Next, the fourth embodiment of the invention will be described below. The following description focuses on the difference from the embodiment described in the above, and omits the descriptions of areas that are identical to those of the embodiment already described.

The third embodiment described above shows that it is possible to group the objects even when the background data (form data) exists. However, the background data becomes a bottleneck in the drawing process due to its large size of the drawing area, and reduces the process paralleling effect. Thus, in the fourth embodiment, a method of eliminating the bottlenecking effect of the drawing process of the background data by means of splitting the background image data to be shared among the groups.

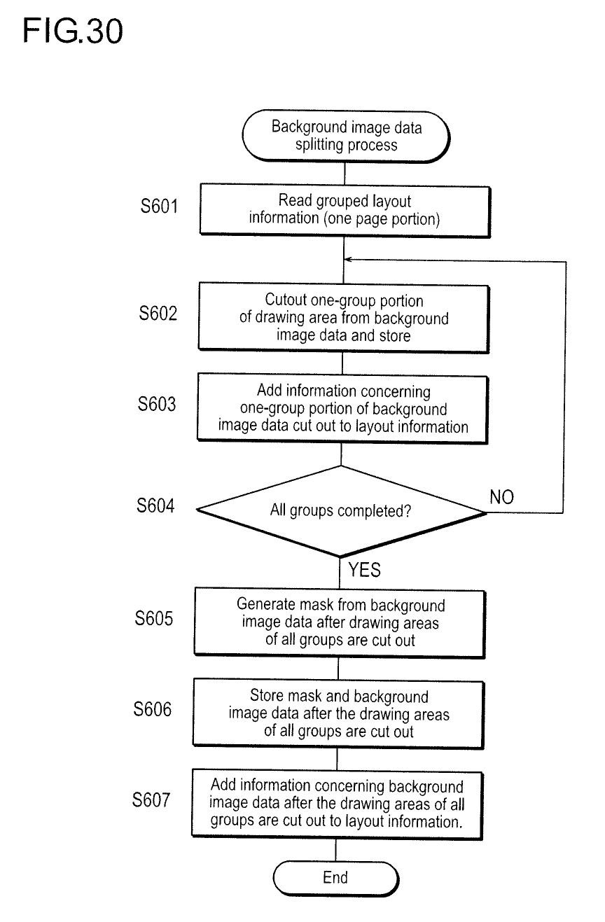

FIG. 30 is a flowchart showing the process for splitting background image data on a printer controller according to the fourth embodiment of the invention. The algorithm shown in the flowcharts of FIG. 30 is stored as a program in a memory unit such as a ROM 22 of the printer controller 2A and executed by CPU 21.

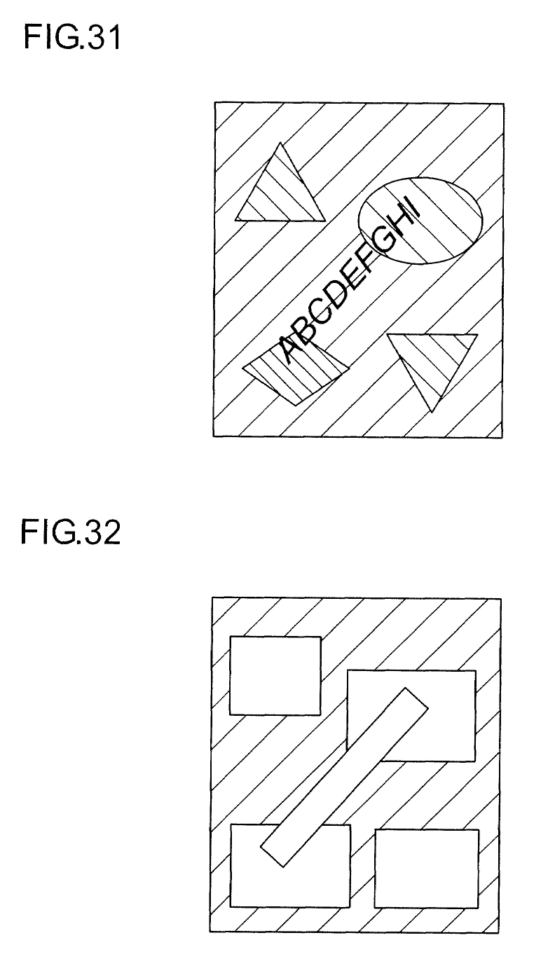

FIG. 31 is a diagram showing a completed example of page image data prepared by synthesizing graphics and characters with the background data. The following describes a case where the page image data shown in FIG. 31 is obtained.

As preamble, the background image data (in case of FIG. 31, it is data, for example, of a single color, blue) and grouping-completed layout information are prepared.

First, the CPU 21 reads the layout information (one-page portion) for which the grouping process is completed (S601).

One-group portion of drawing area is cut out from the background data and stored into the RAM 23. In other words, the background image data is cut out based on the size and location of the rectangular area of the object described for each group in the layout information (S602).

Next, the cutout information concerning the one-group portion of background image data is added to the layout information (S603). The information concerning the cutout one-group portion of the background image data includes the information of the size and location (including the rotary angle) of the rectangular area.

In step S604, a judgment is made as to whether the processing for all groups is completed or not. If the process for all the groups is completed (S604: yes), the program advances to step S605. On the other hand, if there are any groups left with the process to be completed (S604: No), the program returns to the step S602.

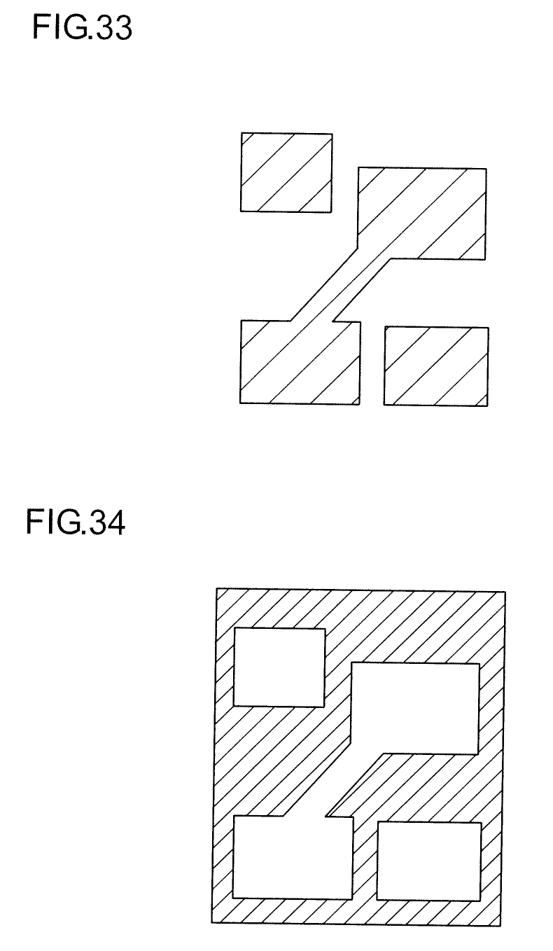

FIG. 32 is a diagram showing the background image data after the drawing areas for all groups are cut out and FIG. 33 is a diagram showing the areas cut out from the background image data.

In step S605, mask image data (hereinafter called “mask”) is generated from the background image data after the drawing areas for all groups are cut out from the background image data (S605). The mask area here matches with the background image data's area after the image areas of all groups have been cut out.

FIG. 34 is a diagram showing an example of the mask.

Next, the background image data after the drawing areas for all groups are cut out and the mask are stored in the RAM 23 (S606).

The information concerning the background image data after the drawing areas of all groups are cut out is added to the layout information (S607). In other words, the information concerning the background image data and the mask are added to the layout information. As the background data, a pixel with a mask of ON (black) is drawn.

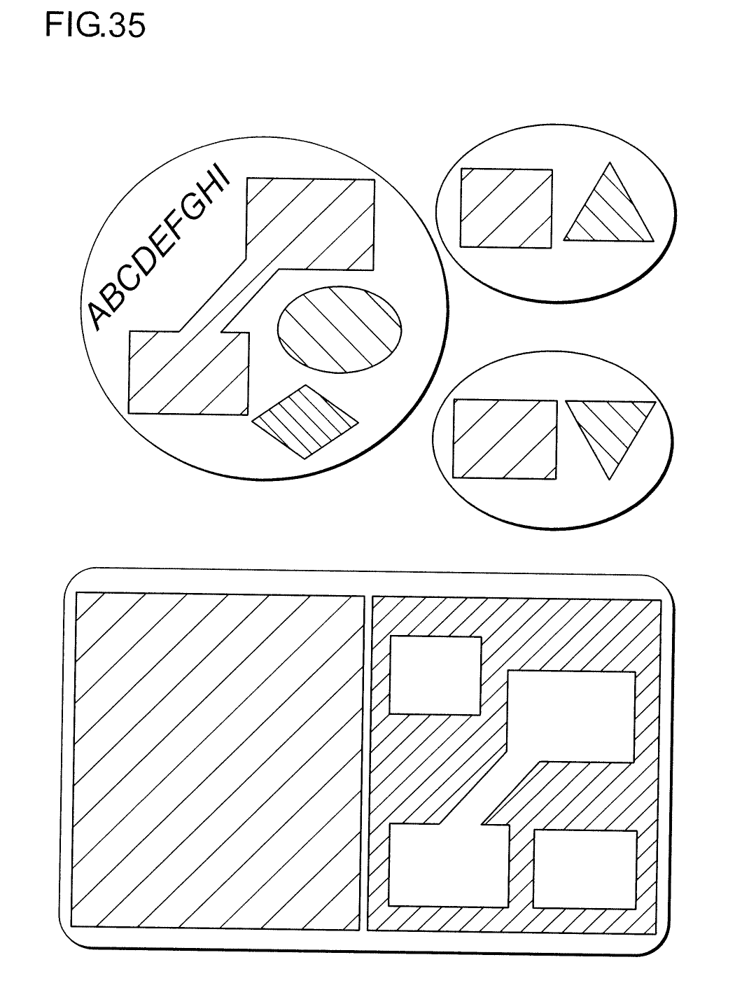

FIG. 35 is a diagram showing how the background image data is split for groups. In an example shown in FIG. 35, there are four groups in total. By synthesizing these four groups in parallel, the bottleneck in drawing background image data can be eliminated. As described before, same layouts are repeated cyclically in the variable data printing method, the cutout background image data parts can be cached in the RAM 23 and reused cyclically.

As can be seen from the above, the printer controller 2A as the image processing apparatus identifies the background image data based on the comparison between the size of the page and the size of the rectangular area of the object using the layout information included in the print data to be processed in the fourth embodiment. The first split part, which is cut out from said background image data in rectangular areas of the overlapping objects, is added to the group of the particular overlapping objects, the second split part, which is cut out from the background image data in a rectangular area of the independent object which does not overlap with another object, is added to the group of the particular independent object, and the background data except the first split part and the second split part is considered as another group.

According to the fourth embodiment, it is not only possible to achieve the same operating effect as in the embodiments described above, but also possible to eliminate the bottleneck caused by the drawing process of the background image data by splitting the background image data and assigning the split parts to various groups.

Next, the fifth embodiment of the invention will be described below. The following description focuses on the difference from the embodiment described in the above, and omits the descriptions of areas that are identical to those of the embodiment already described.

In the embodiments described before, the plurality of objects overlapping with each other is synthesized from the object at the bottom of Z-axis (the bottom of the overlap) to upper objects in order. However, in case of print data with background image data (form data), the background image data at the bottom is drawn regardless of the fact that it is covered up upper part objects. This deteriorates the efficiency of this method. This wasteful drawing can be eliminated by executing object synthesis in the order of top to bottom on the Z-axis in case of print data having background image data. The Z-buffer method can be used as a synthesizing method for this purpose. The Z-buffer method requires, in addition to the raster image data, a mask in order to skip the drawing of overlapping areas. The mask can be generated by the raster image generating unit 213.

In other words, the Z-buffer method requires a mask although the duplicate drawing of overlapping areas is eliminated. However, if the image to be formed is a color image having CMYK color components of high resolution, the synthesizing time of a mask image (1 bit 1 plate) is overwhelmingly shorter than the duplicate synthesizing time of the raster image data (8 bit 4 plates), so that the synthesizing time reduction effect is very high.

As can be seen from the above, the printer controller 2A as the image processing apparatus makes a judgment as to whether or not the background image data exists based on the comparison between the size of the page and the size of the rectangular area of the object using the layout information included in the print data to be processed in the fifth embodiment. If it is judged that the background image data exists, the Z-buffer method is implemented in which raster images generated by rasterizing objects from the top to the bottom in order are synthesized.

According to the fifth embodiment, it is not only possible to achieve the same operating effect as in the embodiments described above, but also possible to eliminate useless drawing of overlapping areas in case background image data exists.

Next, the sixth embodiment of the invention will be described below. The following description focuses on the difference from the embodiment described in the above, and omits the descriptions of areas that are identical to those of the embodiment already described.

In the embodiments described before, the background image data (form data) is processed as an object. However, object groups that are commonly used in a plurality of pages can be combined and treated as background image data (form data).

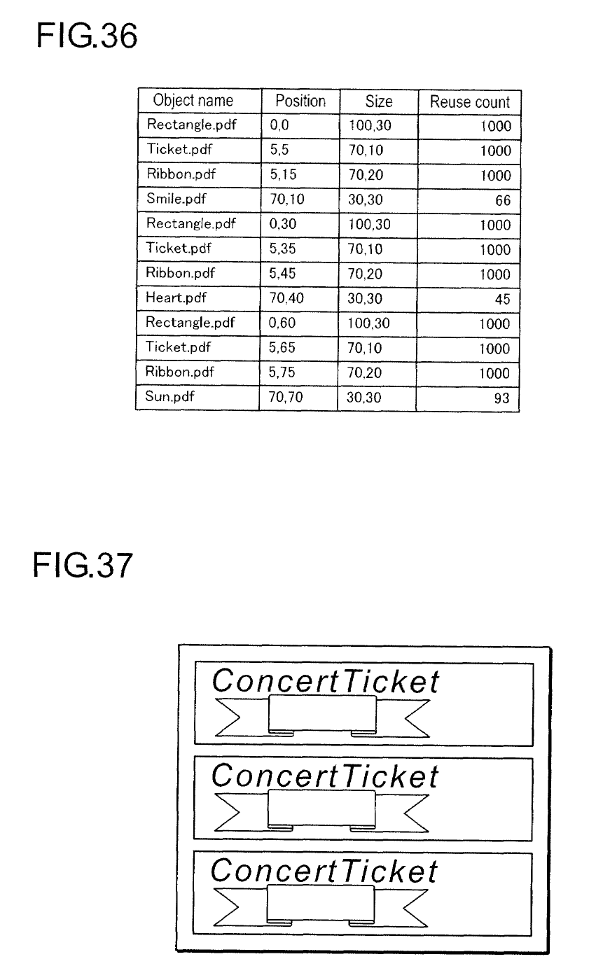

In this case, information concerning the reuse objects in the layout information is extracted for each page and a management list as shown in FIG. 36 is prepared. In case of an example shown in FIG. 36, the total number of pages contained in the print data is 1000. Background image data (form data) is prepared using the reuse objects whose reuse frequency matches with the total number of pages contained in the print data. FIG. 37 is a diagram showing an example of prepared form data. Form data can also be prepared using the reuse objects whose reuse frequency is substantial large although it is less than the total number of pages contained in the print data.

As such, the sixth embodiment allows the printer controller 2A that functions as an image processing apparatus to identify the object group that is commonly used on a plurality of pages within the print data to be processed as background image data (form data). The printer controller 2A treats the identified background image data as one group.

According to the sixth embodiment, it is not only possible to achieve the same operating effect as in the embodiments described above, but also possible to generate background image data by combining the object group commonly used for a plurality of pages, achieving a more efficient processing using the generated background image data (form data).

It is obvious that this invention is not limited to the particular embodiments shown and described above but may be variously changed and modified without departing from the technical concept of this invention.

Although the invention was described in the above embodiments for a case where the printer controller as the image processing apparatus and the printer as the image forming apparatus are installed independently, the printer controller can be installed in the printer.

Also, although the embodiments described above uses a printer as the image forming apparatus, the invention is not limited to it. The present invention is applicable to an image forming apparatus such as MFP (Multi-Function Peripheral) and a copying machine as well.

The means and method of conducting various processes in the printing system according to the present invention can be realized by means of a dedicated hardware circuit, or a programmed computer. Said program can be provided either by a computer readable recording medium such as a flexible disk and a CD-ROM, or by being supplied on-line via a network such as the Internet. In this case, the program recorded on the computer readable recording medium is ordinarily transferred to and stored in a memory unit such as a hard disk. Said program can also be provided as independent application software or can be built into the software of the apparatus as a part of its function.

What is claimed is:

1. An image processing method used on an image processing apparatus having a plurality of processing units for processing print data containing a plurality of objects defining page contents, comprising:
(a) grouping said plurality of objects into one group for overlapping objects one of which overlaps with another object among the overlapping objects, and another group for independent object which does not overlap with another object;
(b) calculating a drawing area for each of the groups obtained by the grouping process in said step (a); and
(c) distributing said groups into the number of parallel processes to be executed by said plurality of processing units based on the drawing area of each group calculated in said step (b).

2. The image processing method as claimed in claim 1, wherein
a distributing process is executed in said step (c) in such a way as to minimize the difference between the total drawing areas of the distributing destinations.

3. The image processing method as claimed in claim 1, wherein
said print data is described in PPML (Personalized Print Markup Language) or PPML/VDX (PPML/Variable Data Exchange), which is a variable print language.

4. The image processing method as claimed in claim 1, wherein
in said step (b), the drawing area is calculated using layout information containing the sizes and locations of rectangular areas of objects located on a page contained in said print data.

5. A computer readable recording medium stored with an image processing program for processing print data containing a plurality of objects defining page contents in order to operate an image processing apparatus having a plurality of processing units, said image processing program causing said image processing apparatus to execute a process comprising:
(a) grouping said plurality of objects into one group for overlapping objects one of which overlaps with another object among the overlapping objects, and another group for independent object which does not overlap with another object;
(b) calculating a drawing area for each of the groups obtained by the grouping process in said step (a): and
(c) distributing said groups into the number of parallel processes to be executed by said plurality of processing units based on the drawing area of each group calculated in said step (b).

6. The computer readable recording medium as claimed in claim 5, wherein
a distributing process is executed in said step (c) in such a way as to minimize the difference between the total drawing areas of the distributing destinations.

7. The computer readable recording medium as claimed in claim 5, wherein
said print data is described in PPML (Personalized Print Markup Language) or PPML/VDX (PPML/Variable Data Exchange), which is a variable print language.

8. The computer readable recording medium as claimed in claim 5, wherein
in said step (b), the drawing area is calculated using layout information containing the sizes and locations of rectangular areas of objects located on a page contained in said print data.

9. The computer readable recording medium as claimed in claim 5, wherein
said step (a) includes:
(a1) preparing pseudo-synthesized image data by drawing in a rectangular area within a page where each object is placed using a pixel value indicating the identification number of the particular object; and
(a2) identifying the overlapping objects and the independent object which does not overlap with another object based on the pixel value of each pixel and the pixel values of pixels adjacent to the particular pixel in pseudo-synthesized image data prepared in said step (a1).

10. The computer readable recording medium as claimed in claim 5, said process further comprising:
(d) executing a synthesizing process in parallel for each distribution destination, preparing page image data by synthesizing raster image data prepared by rasterizing said objects.

11. The computer readable recording medium as claimed in claim 5,
said print data having a plurality of pages;
said process further comprising: (e) comparing the layout indicating the sizes and locations of rectangular areas located on a page by each page using the layout information contained in the print data in order to identify the pages with different layouts; and
causing said image processing apparatus to execute said steps (a) through (c) only on pages with different layouts.

12. The computer readable recording medium as claimed in claim 5, said process further comprising:
(f) identifying background image data based on a comparison of the size of the page with the size of the rectangular area of the object using the layout information contained in said print data, wherein
said background image data is treated as one group in said step (a).

13. The computer readable recording medium as claimed in claim 5, said process further comprising:
(f) identifying background image data based on a comparison of the size of the page with the size of the rectangular area of the object using the layout information contained in said print data, wherein
in said step (a), a first split part, which is cut out from said background image data in rectangular areas of said overlapping objects, is added to the group of the particular overlapping objects, a second split part, which is cut out from the background image data in a rectangular area of said independent object which does not overlap with another object, is added to the group of the particular independent object, and said background data except said first split part and said second split part is considered as another group.

14. The computer readable recording medium as claimed in claim 12, said process further comprising:
(g) making a judgment of whether or not a background image data exists based on a comparison of the size of the page with the size of the rectangular area of the object using the layout information contained in said print data; and
(h) implementing the Z-buffer method in which raster image data generated by rasterizing objects from the top to the bottom in order are synthesized, if it is judged that the background image data exists,.

15. The computer readable recording medium as claimed in claim 5, said process further comprising:
(i) identifying the object group used commonly in a plurality of pages within said print data as background image data,
said background image data being treated as one group in said step (a).

16. The computer readable recording medium as claimed in claim 5, said process further comprising:
(i) identifying the object group used commonly in a plurality of pages within said print data as background image data, wherein
in said step (a), a first split part, which is cut out from said background image data in rectangular areas of said overlapping objects, is added to the group of the particular overlapping objects, a second split part, which is cut out from the background image data in a rectangular area of said independent object which does not overlap with another object, is added to the group of the particular independent object, and said background data except said first split part and said second split part is considered as another group.

17. An image processing apparatus having a plurality of processing units for processing print data containing a plurality of objects defining page contents, comprising:
a grouping unit for grouping said plurality of objects into one group for overlapping objects one of which overlaps with another object among the overlapping objects, and another group for independent object which does not overlap with another object;
a calculating unit for calculating a drawing area for each of the groups obtained by the grouping process by said grouping unit; and
a distributing unit for distributing said groups into the number of parallel processes to be executed by said plurality of processing units based on the drawing area of each group calculated in said calculating unit.

18. The image processing apparatus as claimed in claim 17, wherein
said distributing unit executes a distributing process in such a way as to minimize the difference between the total drawing areas of the distributing destinations.

19. The image processing apparatus as claimed in claim 17, wherein
said print data is described in PPML (Personalized Print Markup Language) or PPML/VDX (PPML/Variable Data Exchange), which is a variable print language.

20. The image processing apparatus as claimed in claim 17, wherein
said calculating unit calculates the drawing area using layout information containing the sizes and locations of rectangular areas of objects located on a page contained in said print data.
